(19) United States
(12) Patent Application Publication
(10) Pub. No.: US 2011/0060574 A1
(43) Pub. Date: Mar. 10, 2011

(54) COMPUTER-BASED MODELING AND DESIGNING OF PHOSPHOFRUCTOKINASE 1 (PFK) MODULATORS

(75) Inventors: Wojciech Rypniewski, Poznan (PL); Katarzyna Banaszak, Poznan (PL); Ingrid Mechin, Bridgewater, NJ (US)

(73) Assignee: INSTYTUT CHEMII BIOORGANICZNEJ PAN, Poznan (PL)

(21) Appl. No.: 12/744,342

(22) PCT Filed: Nov. 25, 2008
(86) PCT No.: PCT/PL2008/000088

§ 371 Date: Aug. 2, 2010

(30) Foreign Application Priority Data
Nov. 25, 2007 (PL) 383866

(51) Int. Cl. G06F 19/16; C07F 9/10

(52) U.S. Cl. 703/11; 549/222

(57) ABSTRACT

The subject matters of the invention are: a crystallographic model of the binding site and a modulator regulating the catalytic activity of phosphofructokinase (PFK), a method of designing, selecting and producing a PFK modulator, a computer based method for the analysis of the interaction between the modulator and PFK, a computer-based method the analysis of molecular structures, a method of assessing the ability of the potential modulator to interact in the binding site on the PFK surface, a method of providing data for generating structures and/or performing design for ligands binding PFK, PFK homologues or analogues, complexes of PFK with a potential modulator, or complexes of PFK homologues or analogues with potential modulators, a computer system. The invention makes it possible to design a suitable activator, which could be used to modulate PFK activity, taking advantage of PFKs capability to bind in its effector site phosphate groups or other groups with a similar potential to interact, which correspond with the substituents in positions 1, 2 and 6 of the fructose ring, or groups corresponding with positions of the fructose ring groups interacting in the PFK effector site.

The subject matters of the invention are: a crystallographic model of the binding site and a modulator regulating the catalytic activity of phosphofructokinase (PFK), a method of designing, selecting and producing a PFK modulator, a computer-based method for the analysis of the interaction between the modulator and PFK, a computer-based method the analysis of molecular structures, a method of assessing the ability of the potential modulator to interact in the binding site on the PFK surface, a method of providing data for generating structures and/or performing design for ligands binding PFK, PFK homologues or analogues, complexes of PFK with a potential modulator, or complexes of PFK homologues or analogues with potential modulators, a computer system. The invention makes it possible to design a suitable activator, which could be used to modulate PFK activity, taking advantage of PFKs capability to bind in its effector site phosphate groups or other groups with a similar potential to interact, which correspond with the substituents in positions 1, 2 and 6 of the fructose ring, or groups corresponding with positions of the fructose ring groups interacting in the PFK effector site.

Glycolysis is the basis of anaerobic and aerobic metabolism processes and occurs in almost all organisms (Fothergill-Gilmore & Michels, 1993). It is the main energy source in many prokaryotes and in the eukaryotic cell types devoid of mitochondria or functioning under low oxygen or anaerobic conditions. During glycolysis one glucose molecule is converted to two molecules of pyruvate while two molecules of ATP are produced. The rate of glycolysis is tightly regulated depending on the cell's needs for energy and building blocks for biosynthetic reactions.

Phosphofructokinase (PFK, EC 2.7.1.11) is the main control point in the glycolytic pathway. PFK catalyses the conversion of fructose-6-phosphate (Fru-6-P) to fructose-1,6-diphosphate (Fru-1,6-P₂) with the simultaneous conversion of ATP to ADP. The reaction releases much of energy, therefore it is practically irreversible. The reverse reaction is catalysed by a fructose-1,6 bisphosphatase (Benkovic & de Maine, 1982). PFK is the enzyme with the most complex regulatory mechanism in the glycolytic pathway. The major isozyme of PFK is PFK1, a multi-subunit oligomeric allosteric enzyme whose activity is modulated by a number of effectors. In general, PFK is sensitive to the “energy level” of the cell, as indicated by the levels of ATP relative to the products of ATP hydrolysis, but the mechanisms of control are different in eukaryotes and prokaryotes. In the relatively well studied prokaryotes PFK is activated in response to “low energy level”, i.e. by the products of ATP hydrolysis, while in eukaryotes PFK is inhibited by ATP (“high energy”) and activated by AMP and, to a lesser extent, by ADP (Hofmann & Kopperschläger, 1982). In a classic case of feedback inhibition PFKs are also inhibited by citrate, allowing feedback from the citric acid cycle (Sols, 1981). In eukaryotes, but not in prokaryotes, PFKs are also activated by fructose-2,6-diphosphate (Fru-2,6-P₂). This potent allosteric regulator, which also inhibits the corresponding bisphosphatase, reflects a higher level of complexity of eukaryotes, compared to prokaryotes. It overrides the inhibition by ATP, which is essential in some tissues (e.g. in muscles), and makes PFK sensitive to the action of the hormones: glucagon and insulin in “higher” organisms (Pilkis et al., 1988; Okar & Lange, 1999).

PFK1 is an allosteric enzyme, showing a characteristic sigmoidal activity profile instead of the common Michaelis-Menten kinetics. The sigmoidal profile indicates co-operativity between the active sites in the oligomeric enzyme. At low substrate concentrations the enzyme shows little activity resulting from its low affinity for the substrate. As the concentration of the substrate increases, so does the substrate affinity and the enzymatic activity. This behaviour is explained in terms of a balance between two alternative forms of the enzyme: the inactive “T-state” and the active “R-state”. The ground state of the enzyme is the T-state. It predominates in the absence of the allosteric substrates and allosteric activators. These ligands bind only to the R-state. The binding stabilises the active form, thus enabling more substrate molecules to bind to the still vacant binding sites in the oligomeric enzyme. In the overall effect, the allosteric substrate and the allosteric activators shift the balance in solution from the enzyme's inactive ground T-state towards the active R-state.

In the past, crystallographic studies focused on PFK1 from prokaryotes: E. coli and B. stearothermophilus. Prokaryotic PFK1 is a homotetramer with a subunit molecular weight of approximately 37 kDa. In the 1980s, the control mechanism of bacterial PFK1 was investigated by means of protein crystallography. The T- and the R-states of the E. coli and B. stearothermophilus enzymes were explained in terms of the proteins' quaternary structure. The transitions between the T- and R-states involves a rearrangement of the enzymes' subunits. The binding sites of the substrate, Fru-6-P, and the allosteric effectors span the inter-subunit interface of the R-state. In the T-state, these ligands cannot bind (Evans & Hudson, 1979; Evans et al., 1981; Shirakihara & Evans 1988; Rypniewski & Evans, 1989; Schirmer & Evans, 1990).

The structures of eukaryotic PFK1 are more complex than in prokaryotes. So is their control mechanism. In yeast, PFK1 is an oligomer of the form α₄β₄. Each subunit is more than twice the size of the prokaryotic PFK1 subunit. The amino acid sequence of each eukaryotic subunit consists of two homologous parts, each half being homologous to a prokaryotic PFK1 subunit. The two types of subunits, α and β, are also homologous in sequence. It has been postulated that yeast PFK1 is the result of two gene duplications: the first tandem duplication resulted in a subunit of double size compared to the prokaryotic subunit, and the second gene duplication created two subunit types (Poorman et al., 1984; Heinisch et al, 1989).

Attempts were made to extend the crystallographic study to include PFK1 in eukaryotes but no suitable crystals could be obtained. Much data were obtained on the eukaryotic PFK by means of biochemistry, enzyme kinetics, genetics, mutagenesis and single-particle electron microscopy but detailed structural information was unavailable.

In the case of PFK1, the allosteric substrate is Fru-6-P (the other substrate, ATP, has no allosteric effect) and there are several allosteric activators of which the most potent is Fru-2,6-P₂, found only in eukaryotes. It abolishes the inhibitory effect of ATP. The Fru-2,6-P₂ binding site, which is part of the regulatory mechanism in eukaryotes, had been proposed, based on amino the acid sequence analysis, which evolved from the active sites that became redundant after the gene duplication and, losing the catalytic function, acquired a regulatory role (Heinisch et al. 1996). However, the Fru-2,6-P₂ binding site has not been described until now in terms of a three-dimensional atomic model.

In the patent application MXPA05011769 (publ. 2006-01-26) crystal of PDE5, its crystalline structure and its use in drug design were presented. The invention relates to the soakable crystals of a phosphodiesterase 5 (PDE5) and their uses in identifying PDE5 ligands, including PDE5 ligands and inhibitor compounds. The present invention also relates to methods of identifying such PDE5 inhibitor compounds and their medical use. The present invention additionally relates to crystals of PDE5 into which ligands may be soaked and crystals of PDE5 10 comprising PDE5 ligands that have been soaked into the crystal.

In the patent application EP 0130030 (publ. 1985-01-02) diagnostic application of phosphofructokinase was described. In the patent application WO2005083069 (publ. 2005-09-09) PDE2 crystal structures for structure based drug design were described. Crystalline compositions of Phosphodiesterase Type 2 (PDE2), particularly of the PDE2 catalytic domain, and amino acid sequences utilized to form such crystalline compositions, which are used to screen PDE2 ligands. The ligands are formulated into pharmaceutical compositions, and used for treatment of disease states or disorders mediated by PDE2. In the patent application WO 2005083069 (publ. 2005-09-09) PDE2 crystal structures for structure based drug design was described. A crystalline compositions of Phosphodiesterase Type 2 (PDE2), particularly of the PDE2 catalytic domain, and amino acid sequences utilized to form such crystalline compositions, which are used to screen PDE2 ligands. The ligands are formulated into pharmaceutical compositions, and used for treatment of disease states or disorders mediated by PDE2.

In the patent application US2006110743 (publ. 2006-05-25) drug evolution: drug design at “hot spots” was described. A new method of designing and generating compounds having an increased probability of being drugs, drug candidates, or biologically active compounds, in particular having a therapeutic utility, is disclosed. The method consists of identifying a group of bioactive compounds, preferably of diverse therapeutic uses or biological activities and built on a common building block. In this group of compounds, side chains modifying the building block are identified and used to generate a second set of compounds according to the proposed methods of “hybridization”, “single substitution” or “incorporation of frequently used side chains”. If the compounds in the second set built on the same building block contain an unusually large number of drugs, preferably with diverse therapeutic uses or biological activities, they constitute a “hot spot”. A focused combinatorial library of the “hot spot” is then generated, preferably by methods of combinatorial chemistry, and compounds of this library are screened for a variety of therapeutic uses or biological activities. The method generates drugs, drug candidates, or biologically active compounds with a high probability, without requiring any prior knowledge of biological targets.

Despite the above-described compounds and methods of designing and generating drugs, drug candidates or biologically active compounds, methods for identifying modulators for metabolic pathways, comprising screening for agents that modulate the activity of enzymes, computer-assisted methods of structure based drug design of different inhibitors using a 3-D structure of proteins, still there is a need for a successful design of an efficient activator or inhibitor which could be used to modulate the PFK activity and designed to exploit the PFK's possibilities to bind at its effector site the phosphate or other groups with similar binding potential corresponding to the ligands at positions 1, 2 and 6 of the fructose ring or groups corresponding with positions of groups of fructose ring, which interact with the effector binding site of PFK.

The goal of the present invention is to provide a method which may be used to obtain stable compounds which would act on PFK analogously to Fru-2,6-P₂, and which could be used as activators of this enzyme.

The fulfillment of this goal and the solution of problems regarding the design of compounds which can interact with the Fru-2,6-P₂ effector binding site and induce enzymatic activity of PFK, as well as the development of the atomic model which enables the design of artificial activators, have been achieved in the present invention.

The subject of invention is a crystallographic model of the binding site wherein it is a part of the eukaryotic phosphofructokinase (PFK), in complex with the allosteric activator D-fructose-2,6-bisphosphate (Fru-2,6-P₂), wherein the atomic coordinates x, y, z of a portion of PFK which determine two homologous binding sites of the activator (effector), including the bound Fru-2,6-P₂ molecules, are presented in Tables 1a and 1b, or a derivative set of transformed coordinates expressed in any reference system.

Preferably, the amino acid residues from Tables 1a or 1b are substituted with the amino acid residues present in a homologous sequence of other eukaryotic PFK.
Preferably, the three-dimensional structure described by means of the atomic coordinates x, y, z, after being superimposed with the least squares minimization method, having the root mean square deviation equal or less than 0.1 nm, in relation to the atomic coordinates x, y, z presented in Tables 1a and 1b.

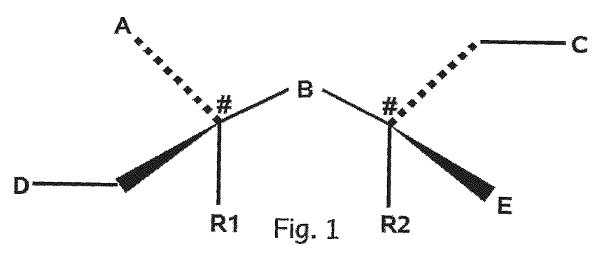

The next subject of the invention is a modulator which regulates the catalytic activity of PFK, wherein said modulator is a compound presented on FIG. 1, where A and C are selected from among the groups: —PO₄, —SO₄ or —C—SO₂O⁻, B is one of the bridges: —O— or —S—; D is selected from among the groups —PO₄, —SO₄, —OH or —C—SO₂O⁻, E is —H, # is an atom C with hybridization sp³; R1 and R2 are either —CXH—OH or —CX═O or —H, where X is a hydrogen atom or bonds with other R groups or bonds with other R groups through the —CH₂—, group; and the —CH₂— groups are between D and # and between C and #. Preferably, the modulator stimulates the catalytic activity of PFK.

The next subject of invention is a method of designing a PFK modulator, wherein the modulator is a compound of the formula presented in FIG. 1, and where A and C are selected from among the groups: —PO₄, —SO₄ or —C—SO₂O⁻; B is one of the bridges —O— or —S—; D is selected from among the groups —PO₄, —SO₄, —OH or —C—SO₂O⁻; E is —H, # is an atom C with hybridization sp³; R1 and R2 are either —CXH—OH or —CX═O or —H, where X is a hydrogen atom or bonds with other R groups or bonds with other R groups through the —CH₂—, group; and the —CH₂— groups are between D and # and between C and #.

Preferably, the modulator design includes:
a) exploring the PFK atomic coordinates which constitute the binding site of the PKF effector presented in tables 1a and 1b to obtain information about the three-dimensional structure and electrostatic properties of the protein surface;
b) designing a PFK modulator using the effector binding site information given in Tables 1a or 1b.

The next subject of the invention is a method of selecting the PFK modulator, wherein the modulator is a compound of the formula presented in FIG. 1, and where A and C are selected from among the groups: —PO₄, —SO₄ or —C—SO₂O⁻, B is one of the bridges: —O— or —S—; D is selected from among the groups —PO₄, —SO₄, —OH or —C—SO₂O⁻; E is —H, # is an atom C with hybridization sp³, R1 and R2 are either —CXH—OH or —CX═O or —H, where X is a hydrogen atom or bonds with other R groups or bonds with other R groups through the —CH₂—, group; and the —CH₂— groups are between D and # and between C and #.

Preferably the modulator design includes:
a) exploring the PFK atomic coordinates which constitute the binding site of the PKF effector, presented in Tables 1a and 1b to obtain information about the structure and properties of the protein surface;
b) selecting a PFK modulator using the effector binding site information given in tables 1a or 1b.

The next subject of invention is a method of producing the PFK modulator, characterised in that it comprised the identification of a compound or designing a compound that fits into the effector site binding pocket of PFK in its uninhibited conformation, wherein the said conformation of the effector site binding pocket of PFK is defined by the x, y, z-coordinates of atoms in the set of amino acid residues given in Tables 1a or 1b.

The next subject of invention is a computer-based method for the analysis of the interaction of a molecular structure with PFK, characterised in that it comprises:
a) providing a structure comprising a three-dimensional representation of PFK effector binding site, whose representation comprises all or a portion of the coordinates given in Tables 1a or 1b, or coordinates whose differences from those are within a root-mean-square deviation (r.m.s.d.) equal or less than 0.1 nm,
b) providing a molecular structure to be fitted to the said PFK effector binding site; and
c) fitting the molecular structure to the PFK structure of a).

The next subject of the invention is a computer-based method for the analysis of molecular structures which comprises:
a) providing the coordinates of at least two atoms of a PFK structure as defined in Tables 1a or 1b, wherein the root mean square deviation for the atoms is equal or less than 0.1 nm (“selected coordinates”);
b) providing a molecular structure to be fitted to the selected coordinates.

The next subject of invention is a method of assessing the ability of a candidate modulator to interact in the binding site on the PFK surface, characterised in that it comprises the steps of:
a) obtaining or synthesising the said candidate modulator;
b) forming a crystallized complex of a PFK protein whose atomic coordinates x, y, z include the coordinates presented in Tables 1a or 1b, or the set of coordinates of a homologous part of protein or candidate modulator expressed in any reference system which, after being superimposed with the least squares minimization method, has the root mean square deviation equal or less than 0.1 nm, in relation to the atomic coordinates x, y, z presented in Tables 1a and 1b;
c) analysing the said complex by X-ray crystallography or NMR spectroscopy to determine the ability of the said candidate modulator to interact with the binding site on the PFK surface.

The next subject of invention is a method of providing data for generating structures and/or designing the drugs which bind the PFK, PFK homologues or analogues, complexes of PFK, or complexes of the PFK homologues or analogues with potential modulators, wherein communication is established with a remote device which contains the computer-readable data comprising at least one of:
a) atomic coordinate data presented in Tables 1a or 1b, or a set of coordinates expressed in any reference system which, after being superimposed with the least squares minimization method, has the root mean square deviation equal or less than 0.1 nm, when such data defines the three-dimensional structure of the effector-binding site on the PFK surface;
b) atomic coordinate data of a target effector binding site on the PFK homologue or analogue surface, generated by homology modelling of the target based on the data from Tables 1a or 1b, with the root mean square deviation from atoms equal or less than 0.1 nm;
c) receiving the said computer-readable data from a remote device.

The next subject of invention is a computer system, characterized in that it contains at least one of:
a) atomic coordinate data presented in Tables 1a or 1b, or such data which, after being superimposed with the least squares minimization method, has the root mean square deviation from the atoms in Tables 1a or 1b equal or less than 0.1 nm, where such data defines the three-dimensional structure of the effector-binding site on the PFK surface or at least its selected coordinates;
b) atomic coordinate data of an effector binding site on the surface of target PFK protein, generated by homology modelling of the target based on the data from Tables 1a or 1b, when the root mean square deviation from atoms from Tables 1a or 1b, after being superimposed with the least squares minimization method, is equal or less than 0.1 nm;
c) atomic coordinate data of an effector binding site on the surface of the target PFK protein, generated by the interpretation of data obtained from the analysis of the X-ray crystallography or NMR, based on the data from Tables 1a or 1b, when the root mean square deviation of atoms from Tables 1a or 1b, after being superimposed with the least squares minimization method, is equal or less than 0.1 nm, and/or
d) crystallographic structure factors, obtained from the atomic coordinates (c) or (d).

The attached figures facilitate a better understanding of the nature of the present invention.

FIG. 1 presents a scheme of a modulator where A and C are selected from —PO₄, —SO₄ or —C—SO₂O⁻ groups, B is selected from —O— or —S— bridge, D is selected from —PO₄, —SO₄, —OH or —C—SO₂O⁻ group, E is —H, # is atom C with hybridization sp³, R1 and R2 are selected from —CXH—OH or —CX═O or —H, where X is a hydrogen atom or a bond to the other R-group or a bond to the other R-group via a —CH2- group. Especially important for the modulator is group C. In case of the activator C is sulphate, phosphate or sulphonic group and interacts with the neighboring subunit of PFK stabilizing the enzyme in the active R-state.

Table 1a and 1b show atomic coordinates in PDB (Protein Data Bank) format of parts of crystallographic atomic PFK from S. cerevisiae (yeast), which are the effector sites on the protein surface, and associated molecules of the effector Fru-2,6-P₂. Table 1a shows the location of the α-chain on the surface and Table 1b shows the appropriate site for the β-chain. These coordinates are empirically defined as a result of a crystallographic analysis and are a starting point for designing the modulator of the enzymatic activity of PFK whose characteristics were described in FIG. 1.

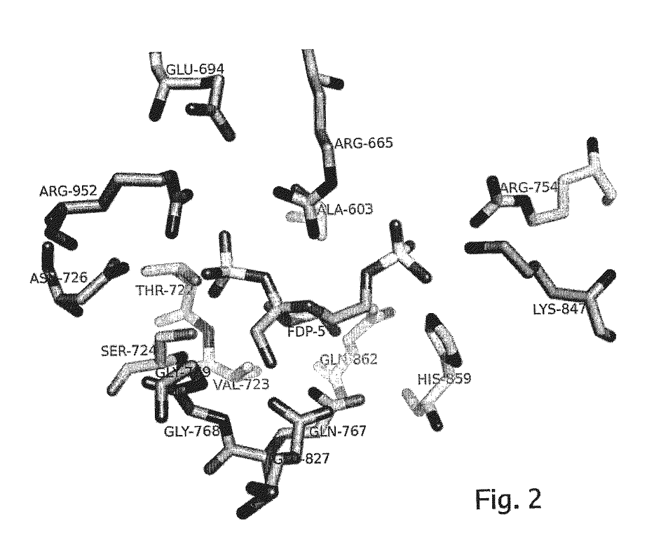

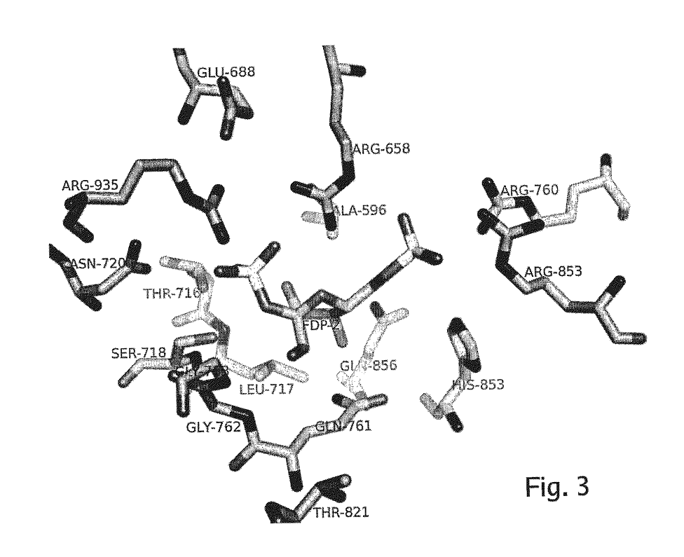

FIG. 2 and FIG. 3 show a representative structures of the effector-binding site in α chain (FIG. 2) and β chain (FIG. 3) These chains in the PFK enzyme are similar but not identical. The PFK molecule is a heterooctamer α₄β₄. Bound effector molecules, fructose-2,6-bisphosphate (FDP-5, FDP-2) are also depicted.

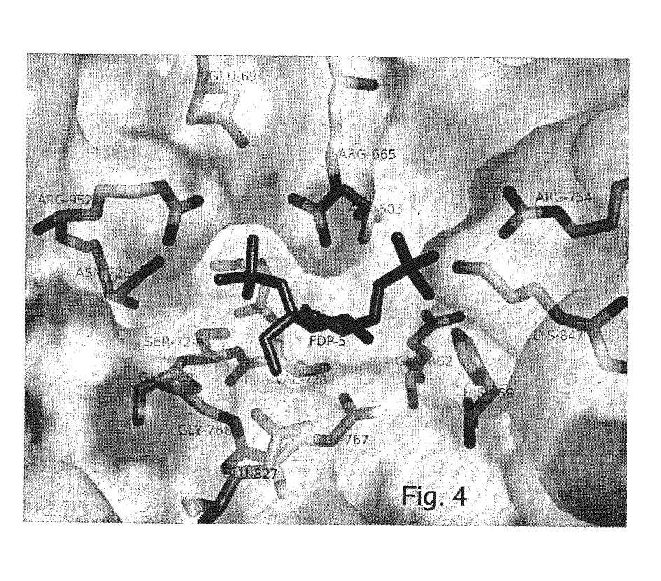

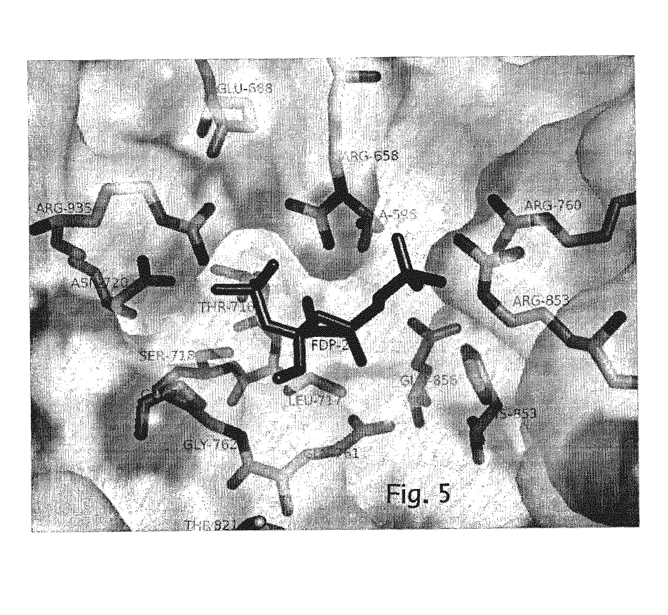

FIG. 4 and FIG. 5 are similar to FIGS. 2 and 3 but they additionally show a rendering of the molecular surface to illustrate the shape of the effector binding cavity.

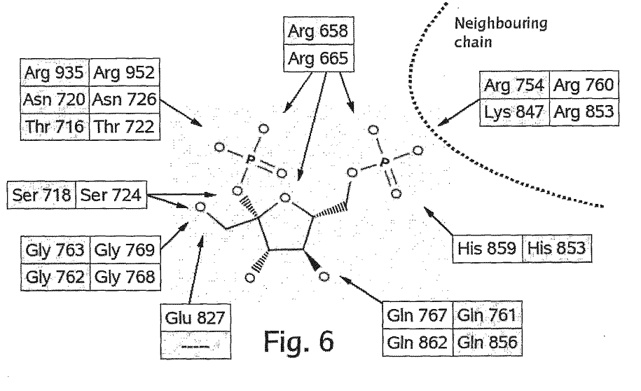

FIG. 6 is a scheme of interactions within the effector binding site, between the PFK and the fructose-2,6-bisphosphate effector. Amino acid residues from the α chain are indicated on a white background while residues from the β chain are shown on a grey background.

Below, there are example embodiments of the present invention defined above.

Determination of the Crystalline Structure of Phosphofructokinase (PFK) in Complex with fructose-6-phosphate (F-6-P) and fructose-2,6-bis-phosphate (Fru-2,6-P2)

The PFK from baker's yeast (Saccharomyces cerevisiae) was prepared according to the Hoffmann and Kopperschlaeger method (1982). The native form of the enzyme, called 21S, was subjected to a limited proteolysis with alpha-chymotrypsin at a ratio of 1:600 to PFK, in the presence of 5 mM ATP. The tetrameric form 12S created as a result of the digestion was subsequently precipitated with ammonium sulfate, the centrifuged sediment was dissolved and dialysed, and then passed twice through the Resource Q column in the HPLC system to remove ATP and low molecular weight proteolytic forms. Protein purified this way was dialysed at 277 K in 20 mM of HEPES, pH 7.4, 1 mM EDTA, 0.2 M sodium acetate, 0.1 M ammonium sulfate, 2 mM DTT, 0.1 mM PMSF and 10 mM F-6-P. The crystals were grown by vapour diffusion in hanging drops at 277 K with a reservoir solution containing 6-10% PEG4000, 0.2 mM sodium acetate in 0.1 M MES buffer, pH 6.0. The crystallization drop initially consisted of 3 microlitres of protein at the mg/ml concentration 8 and 3 microlitres of reservoir solution. Crystals, in the form of long needles of the 0.2 mm diameter, appeared within about two weeks.

The crystallographic data was recorded using synchrotron radiation from the crystal under cryo-conditions at 100 K and stabilized with a solution which comprised glycerol in the 20% concentration (by volume), the components of the reservoir solution, and the ligands Fru-6-P and Fru-2,6-P₂. Crystallographic data was processed with the HKL software package (Otwinowski and Minor, 1997). The crystals belonged to the spatial group P2(1)2(1)2(1) and the dimensions of a unit cell were a=18.0 nm, b=18.6 nm, c=23.7 nm. The crystal structure was determined by molecular replacement (MR) using the PFK tetramer from E. coli as the search model (Shirakihara et al., 1988, PDB code 1pfk). In the determination of the structure important was also the information on the shape of the molecule obtained from electron microscopy (Ruiz et al., 2001). The MR calculations were performed with the AMoRe software (Navaza, 1994). The model obtained via MR method consisted initially of four tetrameric molecules of a bacterial PFK. This model was used to calculate the phases. These phases with experimentally determined amplitudes of X-ray scattering structure factors were used to calculate an electron density map. The map was subjected to non-crystallographic symmetry averaging and solvent flattening with the DM software (Cowtan, 1994). The resulting map significantly differed from the initial one which had systematic errors caused by the inaccurate initial model. The phases and the resolution were extended in the course of numerous DM cycles, from the initial values of 0.15-0.04 nm to the final range of 0.35-0.29. The proof of correctness of the performed phase refinement was the fact that the obtained electron density map included details which were absent in the initial model, for instance the ligand molecules Fru-6-P and Fru-2,6-P₂, and amino acid residues absent in the PFK molecule from E. coli. Subsequently, the chains with target eukaryotic sequence (Saccharomyces cerevisiae) were built into the electron density map, and the atomic model was refined with the CNS program (Brunger et al., 1998). The refinement cycles were interspersed with manual model corrections based on the maps 2Fo-Fc and Fo-Fc. The temperature factors were not refined initially, but with time they were refined for individual side chains and separately for the main chain atoms of individual amino acid residues. The statistics, such as R-factor and R-free (based on 5% of reflections) were monitored, as well as the FOM (figure of merit) (Brunger, 1992). The final values of those statistics were as follows: R=0.238, R-free=0.311, FOM=0.73. The atomic model was validated with the PROCHECK software (Laskowski et al., 1993). All indices were within tolerance limits, or better than what could be expected for a structure determined at such a resolution. For instance, on the Ramachandran plot 79.0% of the amino acid residues are located in the most favoured region, whereas the expected value for the 0.029 nm resolution is 68.7%. The 2Fo-Fc electron density map allows an unambiguous determination of the course of the polypeptide chains and the correct “register” of sequences, because both the density for the main chain and the typical shapes of side chains made such a determination possible. All four independent models of α chains and the β chains are consistent with each other. The parts of the molecule which have their equivalents in the sequence of PFK from E. coli are also consistent in terms of the spatial structure.

The final model includes more than six thousand amino acid residues which constitute eight polypeptide chains (four α and four β), eight molecules of Fru-6-P and eight molecules of Fru-2,6-P₂. These chains, situated in the asymmetric unit of the crystallographic unit cell, have a form very similar to the general shape of the molecule as it was determined by electron microscopy (EM), despite the fact that the crystal contains the 12S molecules, that is the form obtained as a result of partial proteolysis (see above) and being tetrameric in solution, while the EM results are for the native octameric 21 S form. It is however evident that in the crystalline structure the tetrameric 12S molecules associate in pairs, just like in the native form, and create an octamer in which four α subunits constitute the core of the molecule and the β subunits are on the outside. The structures of α and β chains are similar (just like the amino acid sequences), each of them resembling a dimer of the PFK subunits from E. coli. The α and β chains associate in pairs so that their dimer structure resembles the tetramers of the PFK subunits from the bacteria. Four such dimers associate and create the octameric PFK molecule from S. cerevisiae. The determined structure corresponds to the active form (R-state) that is the quaternary form of the molecule, which allows the binding of the Fru-6-P substrate. The binding of Fru-2,6-P₂ in the effector site is analogous to the binding of Fru-6-P in the substrate binding site. Both these ligands are visible in the crystal structure. The other argument for the R form in this crystalline structure is also the comparisons with the structures of bacterial PFK of both forms. The interactions between the subunits in the eukaryote structure are comparable to the active structures of the PFK bacterial forms (R-state), and not to inactive forms (T-state).

The crystalline structure of PFK from S. cerevisiae is the first structure of eukaryotic PFK regulated by Fru-2,6-P₂ (which is typical for eukaryotes) to have been determined experimentally in terms of a three-dimensional atomic model. The model shows detailed interactions of PFK with the activator Fru-2,6-P₂ and explains the mechanism of its action. The effector binds between two subunits and stabilizes the quaternary structure of the enzyme in the active form (R-state). Such a role of the Fru-2,6-P₂ enzyme was earlier postulated on the basis of the evolution consideration, but only here the presented atomic structure of the effector binding site along with the associated Fru-2,6-P₂ molecule allows an understanding of this mechanism in terms of actual interatomic interactions, such as hydrogen bonds or the Van der Waals forces. The accurate determination of the ligand bond site allows also determination of an optimum match of the ligand molecule in the steric sense. The presented model of the effector-ligand binding site is the key to control the activity of the eukaryotic PFK (FIGS. 1 to 6).

The detailed model of the effector binding site of PFK and its interactions with Fru-2,6-P₂ constitute a matrix for the structure-based design of compounds different than the native ligand Fru-2,6-P₂ but sharing with it some common features; the compounds are strong activators or inhibitors of this PFK or related enzymes. It is possible that Fru-1,6-P₂ and Fru-6-P can also bind at the effector binding site. The analysis of the atomic model of the PFK in complex with Fru-2,6-P₂ indicates such a possibility. The PFK surface has a suitable cavity which could accommodate the phosphate group bonded with 1-carbon of the fructose ring. The designing of an artificial effector involves taking advantage of the possibility of fitting and specifically binding appropriate groups in the cavity that constitutes the Fru-2,6-P₂ binding site on the surface of the eukaryotic PFK. The proposed compounds are designed in analogy to the molecule Fru-2,6-P₂ bound in the effector positions on the PFK surface (Tables 1a and 1b). Such a compound has the ability to bind PFK in the sites corresponding to the phosphate group bound with the atom C6 of the fructose ring, and binding PFK in the position corresponding to the phosphate group bound at the atom C2, or in the position corresponding to the substituent at the atom C1, or in the positions corresponding to the fructose ring groups which are capable of making hydrogen bonds.

FIG. 6 provides a summary of the experimentally determined interactions in the effector site. The analysis of such interactions, with due consideration of steric conditions, has resulted in determining the “active part”, or a pharmacofore, of an artificial ligand which would have activator properties and also one which would be a PFK inhibitor. The “active part” is presented in FIG. 1. The activator should have as many as possible of the features defined in the presented diagram and description to FIG. 1. The most important for the activator is the presence of the “C” group corresponding to 6-phosphate in the natural activator Fru-2,6-P₂. Whereas the larger part of the ligand is bound to one PFK subunit, the “C” group binds a neighbouring subunit and stabilizes the quaternary structure of the enzyme in the active form (R-state).

An obvious example of using this invention is the activation of yeast metabolism in industrial applications, such as the brewing industry, distilling industry, and industrial chemical synthesis. The yeasts have a limited tolerance to ethanol which they produce. At a given alcohol concentration, the yeast cells cease to be active. The yeast tolerance limits is well defined, but hard to overcome. If it could be extended even by a small amount, the fermentation results on industrial scale would improve significantly. Using the artificial activator in the fermentation process, particularly in its final stage, should stimulate higher activity of the yeast cells, against their natural tendency to limit the activity level when the alcohol concentration reaches a critical level.

TABLE 1a

| | | | | | | | | | | | | |
|---|---|---|---|---|---|---|---|---|---|---|---|---|
| ATOM | 33233 | N | ARG | F | 754 | −8.057 | −8.485 | 121.415 | 1.00 | 60.96 | F | N |
| ATOM | 33234 | CA | ARG | F | 754 | −7.594 | −9.038 | 122.682 | 1.00 | 61.68 | F | C |
| ATOM | 33235 | CB | ARG | F | 754 | −7.961 | −8.121 | 123.844 | 1.00 | 51.97 | F | C |
| ATOM | 33236 | CG | ARG | F | 754 | −7.836 | −8.789 | 125.217 | 1.00 | 49.71 | F | C |
| ATOM | 33237 | CD | ARG | F | 754 | −7.972 | −7.763 | 126.304 | 1.00 | 49.64 | F | C |
| ATOM | 33238 | NE | ARG | F | 754 | −6.931 | −6.750 | 126.153 | 1.00 | 49.96 | F | N |
| ATOM | 33239 | CZ | ARG | F | 754 | −6.783 | −5.698 | 126.953 | 1.00 | 49.95 | F | C |
| ATOM | 33240 | NH1 | ARG | F | 754 | −7.616 | −5.511 | 127.971 | 1.00 | 49.14 | F | N |
| ATOM | 33241 | NH2 | ARG | F | 754 | −5.794 | −4.839 | 126.738 | 1.00 | 48.11 | F | N |
| ATOM | 33242 | C | ARG | F | 754 | −8.076 | −10.433 | 123.025 | 1.00 | 62.07 | F | C |
| ATOM | 33243 | O | ARG | F | 754 | −9.244 | −10.781 | 122.820 | 1.00 | 63.60 | F | O |
| ATOM | 33926 | N | LYS | F | 847 | −4.159 | −10.783 | 128.058 | 1.00 | 51.37 | F | N |
| ATOM | 33927 | CA | LYS | F | 847 | −4.101 | −10.402 | 129.456 | 1.00 | 52.31 | F | C |
| ATOM | 33928 | CB | LYS | F | 847 | −5.087 | −9.266 | 129.772 | 1.00 | 49.97 | F | C |
| ATOM | 33929 | CG | LYS | F | 847 | −4.612 | −7.861 | 129.409 | 1.00 | 50.20 | F | C |
| ATOM | 33930 | CD | LYS | F | 847 | −3.440 | −7.402 | 130.273 | 1.00 | 50.36 | F | C |
| ATOM | 33931 | CE | LYS | F | 847 | −3.092 | −5.948 | 130.013 | 1.00 | 48.67 | F | C |
| ATOM | 33932 | NZ | LYS | F | 847 | −4.214 | −5.059 | 130.402 | 1.00 | 48.72 | F | N |
| ATOM | 33933 | C | LYS | F | 847 | −4.461 | −11.612 | 130.288 | 1.00 | 52.57 | F | C |
| ATOM | 33934 | O | LYS | F | 847 | −5.297 | −12.432 | 129.898 | 1.00 | 53.90 | F | O |
| ATOM | 26243 | N | ALA | E | 603 | −11.442 | 1.471 | 129.846 | 1.00 | 46.04 | E | N |
| ATOM | 26244 | CA | ALA | E | 603 | −11.603 | 0.034 | 129.897 | 1.00 | 45.47 | E | C |
| ATOM | 26245 | CB | ALA | E | 603 | −10.989 | −0.533 | 131.163 | 1.00 | 71.43 | E | C |
| ATOM | 26246 | C | ALA | E | 603 | −13.113 | −0.172 | 129.894 | 1.00 | 44.51 | E | C |
| ATOM | 26247 | O | ALA | E | 603 | −13.884 | 0.734 | 130.254 | 1.00 | 43.55 | E | O |
| ATOM | 26706 | N | ARG | E | 665 | −8.389 | 2.568 | 125.763 | 1.00 | 45.24 | E | N |
| ATOM | 26707 | CA | ARG | E | 665 | −7.739 | 3.675 | 126.471 | 1.00 | 45.83 | E | C |
| ATOM | 26708 | CB | ARG | E | 665 | −6.692 | 3.124 | 127.446 | 1.00 | 46.97 | E | C |
| ATOM | 26709 | CG | ARG | E | 665 | −7.242 | 2.268 | 128.567 | 1.00 | 46.99 | E | C |
| ATOM | 26710 | CD | ARG | E | 665 | −6.099 | 1.757 | 129.445 | 1.00 | 48.49 | E | C |
| ATOM | 26711 | NE | ARG | E | 665 | −6.571 | 0.819 | 130.462 | 1.00 | 49.00 | E | N |
| ATOM | 26712 | CZ | ARG | E | 665 | −7.375 | 1.143 | 131.472 | 1.00 | 49.18 | E | C |
| ATOM | 26713 | NH1 | ARG | E | 665 | −7.804 | 2.386 | 131.628 | 1.00 | 50.34 | E | N |
| ATOM | 26714 | NH2 | ARG | E | 665 | −7.772 | 0.219 | 132.326 | 1.00 | 50.65 | E | N |
| ATOM | 26715 | C | ARG | E | 665 | −7.095 | 4.757 | 125.602 | 1.00 | 44.81 | E | C |
| ATOM | 26716 | O | ARG | E | 665 | −6.649 | 5.779 | 126.122 | 1.00 | 44.15 | E | O |
| ATOM | 26931 | N | GLU | E | 694 | −9.377 | 8.324 | 131.199 | 1.00 | 40.89 | E | N |
| ATOM | 26932 | CA | GLU | E | 694 | −8.965 | 8.635 | 129.831 | 1.00 | 40.87 | E | C |
| ATOM | 26933 | CB | GLU | E | 694 | −8.605 | 7.373 | 129.052 | 1.00 | 57.96 | E | C |
| ATOM | 26934 | CG | GLU | E | 694 | −7.149 | 6.976 | 129.157 | 1.00 | 58.96 | E | C |
| ATOM | 26935 | CD | GLU | E | 694 | −6.761 | 6.489 | 130.542 | 1.00 | 59.23 | E | C |
| ATOM | 26936 | OE1 | GLU | E | 694 | −7.193 | 5.377 | 130.927 | 1.00 | 57.97 | E | O |
| ATOM | 26937 | OE2 | GLU | E | 694 | −6.027 | 7.229 | 131.236 | 1.00 | 59.39 | E | O |
| ATOM | 26938 | C | GLU | E | 694 | −10.072 | 9.368 | 129.091 | 1.00 | 42.65 | E | C |
| ATOM | 26939 | O | GLU | E | 694 | −9.802 | 10.148 | 128.176 | 1.00 | 43.60 | E | O |
| ATOM | 27157 | N | THR | E | 722 | −16.743 | 3.679 | 134.668 | 1.00 | 47.10 | E | N |
| ATOM | 27158 | CA | THR | E | 722 | −15.591 | 2.853 | 135.000 | 1.00 | 47.36 | E | C |
| ATOM | 27159 | CB | THR | E | 722 | −14.299 | 3.700 | 135.021 | 1.00 | 34.01 | E | C |
| ATOM | 27160 | OG1 | THR | E | 722 | −13.200 | 2.895 | 135.455 | 1.00 | 34.33 | E | O |
| ATOM | 27161 | CG2 | THR | E | 722 | −14.461 | 4.896 | 135.965 | 1.00 | 32.86 | E | C |
| ATOM | 27162 | C | THR | E | 722 | −15.852 | 2.311 | 136.390 | 1.00 | 47.81 | E | C |
| ATOM | 27163 | O | THR | E | 722 | −16.289 | 3.042 | 137.264 | 1.00 | 47.67 | E | O |
| ATOM | 27164 | N | VAL | E | 723 | −15.593 | 1.028 | 136.587 | 1.00 | 48.94 | E | N |
| ATOM | 27165 | CA | VAL | E | 723 | −15.797 | 0.399 | 137.886 | 1.00 | 50.18 | E | C |
| ATOM | 27166 | CB | VAL | E | 723 | −15.318 | −1.069 | 137.875 | 1.00 | 29.18 | E | C |
| ATOM | 27167 | CG1 | VAL | E | 723 | −16.163 | −1.892 | 136.926 | 1.00 | 28.90 | E | C |
| ATOM | 27168 | CG2 | VAL | E | 723 | −13.856 | −1.141 | 137.461 | 1.00 | 28.65 | E | C |
| ATOM | 27169 | C | VAL | E | 723 | −15.006 | 1.146 | 138.959 | 1.00 | 51.77 | E | C |
| ATOM | 27170 | O | VAL | E | 723 | −15.462 | 1.340 | 140.083 | 1.00 | 53.93 | E | O |
| ATOM | 27171 | N | SER | E | 724 | −13.801 | 1.570 | 138.593 | 1.00 | 42.80 | E | N |
| ATOM | 27172 | CA | SER | E | 724 | −12.931 | 2.294 | 139.514 | 1.00 | 42.60 | E | C |
| ATOM | 27173 | CB | SER | E | 724 | −11.799 | 2.985 | 138.750 | 1.00 | 57.07 | E | C |
| ATOM | 27174 | OG | SER | E | 724 | −10.980 | 2.038 | 138.086 | 1.00 | 61.04 | E | O |
| ATOM | 27175 | C | SER | E | 724 | −13.716 | 3.319 | 140.328 | 1.00 | 40.83 | E | C |
| ATOM | 27176 | O | SER | E | 724 | −13.568 | 3.402 | 141.547 | 1.00 | 40.54 | E | O |
| ATOM | 27185 | N | ASN | E | 726 | −13.057 | 6.538 | 139.474 | 1.00 | 40.23 | E | N |
| ATOM | 27186 | CA | ASN | E | 726 | −11.943 | 7.459 | 139.631 | 1.00 | 39.80 | E | C |
| ATOM | 27187 | CB | ASN | E | 726 | −10.617 | 6.730 | 139.390 | 1.00 | 40.26 | E | C |
| ATOM | 27188 | CG | ASN | E | 726 | −10.408 | 6.343 | 137.928 | 1.00 | 42.08 | E | C |
| ATOM | 27189 | OD1 | ASN | E | 726 | −11.345 | 6.345 | 137.128 | 1.00 | 42.97 | E | O |
| ATOM | 27190 | ND2 | ASN | E | 726 | −9.171 | 5.988 | 137.581 | 1.00 | 42.90 | E | N |
| ATOM | 27191 | C | ASN | E | 726 | −12.031 | 8.644 | 138.698 | 1.00 | 40.02 | E | C |
| ATOM | 27192 | O | ASN | E | 726 | −11.018 | 9.075 | 138.144 | 1.00 | 41.23 | E | O |
| ATOM | 27499 | N | GLN | E | 767 | −10.146 | −4.183 | 142.154 | 1.00 | 56.79 | E | N |
| ATOM | 27500 | CA | GLN | E | 767 | −9.698 | −3.192 | 141.181 | 1.00 | 54.80 | E | C |
| ATOM | 27501 | CB | GLN | E | 767 | −10.398 | −3.412 | 139.845 | 1.00 | 48.75 | E | C |
| ATOM | 27502 | CG | GLN | E | 767 | −9.861 | −4.597 | 139.078 | 1.00 | 48.20 | E | C |
| ATOM | 27503 | CD | GLN | E | 767 | −10.422 | −4.699 | 137.676 | 1.00 | 47.57 | E | C |
| ATOM | 27504 | OE1 | GLN | E | 767 | −9.963 | −5.513 | 136.875 | 1.00 | 46.04 | E | O |
| ATOM | 27505 | NE2 | GLN | E | 767 | −11.420 | −3.874 | 137.369 | 1.00 | 47.00 | E | N |
| ATOM | 27506 | C | GLN | E | 767 | −9.943 | −1.766 | 141.637 | 1.00 | 54.64 | E | C |
| ATOM | 27507 | O | GLN | E | 767 | −10.456 | −1.539 | 142.731 | 1.00 | 55.62 | E | O |
| ATOM | 27508 | N | GLY | E | 768 | −9.567 | −0.807 | 140.789 | 1.00 | 50.62 | E | N |
| ATOM | 27509 | CA | GLY | E | 768 | −9.761 | 0.603 | 141.104 | 1.00 | 49.39 | E | C |
| ATOM | 27510 | C | GLY | E | 768 | −8.555 | 1.518 | 140.898 | 1.00 | 48.56 | E | C |
| ATOM | 27511 | O | GLY | E | 768 | −8.613 | 2.706 | 141.220 | 1.00 | 47.27 | E | O |
| ATOM | 27512 | N | GLY | E | 769 | −7.467 | 0.981 | 140.355 | 1.00 | 48.44 | E | N |
| ATOM | 27513 | CA | GLY | E | 769 | −6.288 | 1.796 | 140.157 | 1.00 | 48.52 | E | C |
| ATOM | 27514 | C | GLY | E | 769 | −5.882 | 2.430 | 141.478 | 1.00 | 48.98 | E | C |
| ATOM | 27515 | O | GLY | E | 769 | −5.939 | 1.784 | 142.517 | 1.00 | 50.43 | E | O |
| ATOM | 27966 | N | GLU | E | 827 | −5.497 | −2.722 | 144.176 | 1.00 | 54.56 | E | N |
| ATOM | 27967 | CA | GLU | E | 827 | −4.381 | −2.981 | 143.246 | 1.00 | 54.30 | E | C |
| ATOM | 27968 | CB | GLU | E | 827 | −4.786 | −2.716 | 141.791 | 1.00 | 58.97 | E | C |
| ATOM | 27969 | CG | GLU | E | 827 | −5.933 | −3.497 | 141.202 | 1.00 | 58.82 | E | C |
| ATOM | 27970 | CD | GLU | E | 827 | −6.282 | −2.979 | 139.813 | 1.00 | 59.12 | E | C |
| ATOM | 27971 | OE1 | GLU | E | 827 | −6.551 | −1.765 | 139.679 | 1.00 | 59.54 | E | O |
| ATOM | 27972 | OE2 | GLU | E | 827 | −6.284 | −3.776 | 138.856 | 1.00 | 59.50 | E | O |
| ATOM | 27973 | C | GLU | E | 827 | −3.151 | −2.110 | 143.478 | 1.00 | 54.38 | E | C |
| ATOM | 27974 | O | GLU | E | 827 | −2.012 | −2.573 | 143.396 | 1.00 | 54.67 | E | O |
| ATOM | 28199 | N | HIS | E | 859 | −10.672 | −9.309 | 135.849 | 1.00 | 43.96 | E | N |
| ATOM | 28200 | CA | HIS | E | 859 | −11.599 | −8.642 | 134.955 | 1.00 | 42.22 | E | C |
| ATOM | 28201 | CB | HIS | E | 859 | −11.156 | −8.851 | 133.499 | 1.00 | 44.60 | E | C |
| ATOM | 28202 | CG | HIS | E | 859 | −10.057 | −7.924 | 133.079 | 1.00 | 44.48 | E | C |
| ATOM | 28203 | CD2 | HIS | E | 859 | −10.091 | −6.757 | 132.392 | 1.00 | 44.35 | E | C |
| ATOM | 28204 | ND1 | HIS | E | 859 | −8.745 | −8.101 | 133.465 | 1.00 | 44.66 | E | N |
| ATOM | 28205 | CE1 | HIS | E | 859 | −8.018 | −7.083 | 133.036 | 1.00 | 43.57 | E | C |
| ATOM | 28206 | NE2 | HIS | E | 859 | −8.811 | −6.254 | 132.382 | 1.00 | 44.22 | E | N |
| ATOM | 28207 | C | HIS | E | 859 | −13.085 | −8.919 | 135.109 | 1.00 | 40.45 | E | C |
| ATOM | 28208 | O | HIS | E | 859 | −13.900 | −8.225 | 134.499 | 1.00 | 39.42 | E | O |
| ATOM | 28225 | N | GLN | E | 862 | −15.810 | −6.234 | 136.010 | 1.00 | 45.03 | E | N |
| ATOM | 28226 | CA | GLN | E | 862 | −16.440 | −5.329 | 135.047 | 1.00 | 44.85 | E | C |
| ATOM | 28227 | CB | GLN | E | 862 | −15.731 | −5.376 | 133.706 | 1.00 | 41.80 | E | C |
| ATOM | 28228 | CG | GLN | E | 862 | −14.429 | −4.627 | 133.689 | 1.00 | 42.36 | E | C |
| ATOM | 28229 | CD | GLN | E | 862 | −13.614 | −4.941 | 132.457 | 1.00 | 43.95 | E | C |
| ATOM | 28230 | OE1 | GLN | E | 862 | −12.451 | −4.541 | 132.350 | 1.00 | 45.62 | E | O |
| ATOM | 28231 | NE2 | GLN | E | 862 | −14.218 | −5.672 | 131.511 | 1.00 | 43.67 | E | N |
| ATOM | 28232 | C | GLN | E | 862 | −17.899 | −5.688 | 134.849 | 1.00 | 46.08 | E | C |
| ATOM | 28233 | O | GLN | E | 862 | −18.715 | −4.830 | 134.514 | 1.00 | 45.77 | E | O |
| ATOM | 28726 | N | ARG | E | 952 | −4.527 | 9.341 | 138.541 | 1.00 | 46.53 | E | N |
| ATOM | 28727 | CA | ARG | E | 952 | −5.670 | 9.279 | 137.643 | 1.00 | 42.59 | E | C |
| ATOM | 28728 | CB | ARG | E | 952 | −5.553 | 8.062 | 136.727 | 1.00 | 52.48 | E | C |
| ATOM | 28729 | CG | ARG | E | 952 | −4.333 | 8.078 | 135.821 | 1.00 | 51.19 | E | C |
| ATOM | 28730 | CD | ARG | E | 952 | −4.202 | 6.786 | 135.033 | 1.00 | 50.26 | E | C |
| ATOM | 28731 | NE | ARG | E | 952 | −5.407 | 6.464 | 134.270 | 1.00 | 50.19 | E | N |
| ATOM | 28732 | CZ | ARG | E | 952 | −6.420 | 5.732 | 134.722 | 1.00 | 49.56 | E | C |
| ATOM | 28733 | NH1 | ARG | E | 952 | −6.393 | 5.231 | 135.944 | 1.00 | 50.34 | E | N |
| ATOM | 28734 | NH2 | ARG | E | 952 | −7.465 | 5.500 | 133.949 | 1.00 | 49.07 | E | N |
| ATOM | 28735 | C | ARG | E | 952 | −6.956 | 9.179 | 138.431 | 1.00 | 40.06 | E | C |
| ATOM | 28736 | O | ARG | E | 952 | −7.740 | 8.267 | 138.218 | 1.00 | 40.57 | E | O |
| ATOM | 46526 | O2P | FDP | P | 5 | −8.320 | 3.029 | 136.143 | 1.00 | 64.30 | P | O |
| ATOM | 46527 | P1 | FDP | P | 5 | −9.484 | 2.294 | 135.308 | 1.00 | 64.97 | P | P |
| ATOM | 46528 | O3P | FDP | P | 5 | −9.695 | 3.178 | 133.979 | 1.00 | 64.42 | P | O |
| ATOM | 46529 | O1P | FDP | P | 5 | −10.741 | 2.182 | 136.083 | 1.00 | 65.03 | P | O |
| ATOM | 46530 | O2 | FDP | P | 5 | −8.887 | 0.876 | 134.827 | 1.00 | 64.82 | P | O |
| ATOM | 46531 | C2 | FDP | P | 5 | −8.854 | −0.294 | 135.658 | 1.00 | 64.30 | P | C |
| ATOM | 46532 | C1 | FDP | P | 5 | −8.491 | 0.074 | 137.100 | 1.00 | 63.69 | P | C |
| ATOM | 46533 | O1 | FDP | P | 5 | −8.454 | −1.102 | 137.912 | 1.00 | 60.73 | P | O |
| ATOM | 46534 | O5 | FDP | P | 5 | −7.846 | −1.171 | 135.132 | 1.00 | 64.50 | P | O |
| ATOM | 46535 | C3 | FDP | P | 5 | −10.174 | −1.073 | 135.604 | 1.00 | 65.04 | P | C |
| ATOM | 46536 | O3 | FDP | P | 5 | −11.251 | −0.224 | 135.196 | 1.00 | 64.96 | P | O |
| ATOM | 46537 | C4 | FDP | P | 5 | −9.882 | −2.089 | 134.503 | 1.00 | 64.39 | P | C |
| ATOM | 46538 | O4 | FDP | P | 5 | −10.747 | −3.220 | 134.650 | 1.00 | 63.58 | P | O |
| ATOM | 46539 | C5 | FDP | P | 5 | −8.454 | −2.454 | 134.903 | 1.00 | 64.67 | P | C |
| ATOM | 46540 | C6 | FDP | P | 5 | −7.727 | −3.266 | 133.832 | 1.00 | 65.81 | P | C |
| ATOM | 46541 | O6 | FDP | P | 5 | −7.767 | −2.603 | 132.564 | 1.00 | 67.34 | P | O |
| ATOM | 46542 | P2 | FDP | P | 5 | −7.026 | −3.240 | 131.285 | 1.00 | 68.65 | P | P |
| ATOM | 46543 | O5P | FDP | P | 5 | −6.305 | −4.587 | 131.796 | 1.00 | 67.22 | P | O |
| ATOM | 46544 | O6P | FDP | P | 5 | −8.223 | −3.684 | 130.301 | 1.00 | 68.83 | P | O |
| ATOM | 46545 | O4P | FDP | P | 5 | −6.078 | −2.304 | 130.641 | 1.00 | 67.08 | P | O |
| END | | | | | | | | | | | | |

TABLE 1b

| | | | | | | | | | | | | |
|---|---|---|---|---|---|---|---|---|---|---|---|---|
| ATOM | 4238 | N | ARG | A | 760 | 19.077 | 71.248 | 89.275 | 1.00 | 66.25 | A | N |
| ATOM | 4239 | CA | ARG | A | 760 | 18.203 | 70.781 | 90.326 | 1.00 | 64.93 | A | C |
| ATOM | 4240 | CB | ARG | A | 760 | 16.781 | 71.291 | 90.071 | 1.00 | 51.29 | A | C |
| ATOM | 4241 | CG | ARG | A | 760 | 15.726 | 70.610 | 90.902 | 1.00 | 50.50 | A | C |
| ATOM | 4242 | CD | ARG | A | 760 | 14.391 | 71.303 | 90.765 | 1.00 | 49.71 | A | C |
| ATOM | 4243 | NE | ARG | A | 760 | 14.395 | 72.656 | 91.328 | 1.00 | 47.57 | A | N |
| ATOM | 4244 | CZ | ARG | A | 760 | 13.284 | 73.355 | 91.539 | 1.00 | 47.02 | A | C |
| ATOM | 4245 | NH1 | ARG | A | 760 | 12.113 | 72.816 | 91.237 | 1.00 | 47.43 | A | N |
| ATOM | 4246 | NH2 | ARG | A | 760 | 13.330 | 74.584 | 92.030 | 1.00 | 46.43 | A | N |
| ATOM | 4247 | C | ARG | A | 760 | 18.233 | 69.261 | 90.420 | 1.00 | 64.58 | A | C |
| ATOM | 4248 | O | ARG | A | 760 | 18.213 | 68.554 | 89.405 | 1.00 | 64.15 | A | O |
| ATOM | 4954 | N | ARG | A | 853 | 14.782 | 68.630 | 95.568 | 1.00 | 44.54 | A | N |
| ATOM | 4955 | CA | ARG | A | 853 | 13.363 | 68.336 | 95.685 | 1.00 | 46.94 | A | C |
| ATOM | 4956 | CB | ARG | A | 853 | 12.608 | 68.673 | 94.388 | 1.00 | 38.58 | A | C |
| ATOM | 4957 | CG | ARG | A | 853 | 12.391 | 70.171 | 94.140 | 1.00 | 35.99 | A | C |
| ATOM | 4958 | CD | ARG | A | 853 | 11.439 | 70.806 | 95.154 | 1.00 | 33.30 | A | C |
| ATOM | 4959 | NE | ARG | A | 853 | 11.210 | 72.236 | 94.918 | 1.00 | 30.21 | A | N |
| ATOM | 4960 | CZ | ARG | A | 853 | 12.129 | 73.179 | 95.091 | 1.00 | 27.44 | A | C |
| ATOM | 4961 | NH1 | ARG | A | 853 | 13.337 | 72.838 | 95.497 | 1.00 | 28.12 | A | N |
| ATOM | 4962 | NH2 | ARG | A | 853 | 11.844 | 74.460 | 94.879 | 1.00 | 24.54 | A | N |
| ATOM | 4963 | C | ARG | A | 853 | 13.197 | 66.868 | 96.025 | 1.00 | 49.22 | A | C |
| ATOM | 4964 | O | ARG | A | 853 | 14.086 | 66.045 | 95.791 | 1.00 | 48.57 | A | O |
| ATOM | 8816 | N | ALA | B | 596 | 7.520 | 78.037 | 86.751 | 1.00 | 42.66 | B | N |
| ATOM | 8817 | CA | ALA | B | 596 | 7.790 | 76.616 | 86.760 | 1.00 | 41.63 | B | C |
| ATOM | 8818 | C | ALA | B | 596 | 6.962 | 75.944 | 87.839 | 1.00 | 52.25 | B | C |
| ATOM | 8819 | C | ALA | B | 596 | 7.463 | 76.020 | 85.407 | 1.00 | 41.31 | B | C |
| ATOM | 8820 | O | ALA | B | 596 | 6.757 | 76.623 | 84.602 | 1.00 | 41.28 | B | O |
| ATOM | 9289 | N | ARG | B | 658 | 12.243 | 81.331 | 88.859 | 1.00 | 55.29 | B | N |
| ATOM | 9290 | CA | ARG | B | 658 | 11.252 | 82.230 | 89.436 | 1.00 | 54.74 | B | C |
| ATOM | 9291 | CB | ARG | B | 658 | 10.670 | 81.612 | 90.727 | 1.00 | 45.12 | B | C |
| ATOM | 9292 | CG | ARG | B | 658 | 9.703 | 80.429 | 90.531 | 1.00 | 43.86 | B | C |
| ATOM | 9293 | CD | ARG | B | 658 | 9.410 | 79.734 | 91.866 | 1.00 | 44.11 | B | C |
| ATOM | 9294 | NE | ARG | B | 658 | 8.699 | 78.459 | 91.718 | 1.00 | 43.60 | B | N |
| ATOM | 9295 | CZ | ARG | B | 658 | 7.391 | 78.344 | 91.489 | 1.00 | 43.55 | B | C |
| ATOM | 9296 | NH1 | ARG | B | 658 | 6.636 | 79.433 | 91.388 | 1.00 | 43.76 | B | N |
| ATOM | 9297 | NH2 | ARG | B | 658 | 6.841 | 77.142 | 91.348 | 1.00 | 41.28 | B | N |
| ATOM | 9298 | C | ARG | B | 658 | 11.754 | 83.635 | 89.732 | 1.00 | 54.72 | B | C |
| ATOM | 9299 | O | ARG | B | 658 | 10.983 | 84.470 | 90.208 | 1.00 | 55.44 | B | O |
| ATOM | 9532 | N | GLU | B | 688 | 4.811 | 84.215 | 88.481 | 1.00 | 64.06 | B | N |
| ATOM | 9533 | CA | GLU | B | 688 | 6.066 | 84.927 | 88.662 | 1.00 | 65.43 | B | C |
| ATOM | 9534 | CB | GLU | B | 688 | 7.217 | 83.927 | 88.810 | 1.00 | 59.75 | B | C |
| ATOM | 9535 | CG | GLU | B | 688 | 7.019 | 82.962 | 89.974 | 1.00 | 59.29 | B | C |
| ATOM | 9536 | CD | GLU | B | 688 | 6.463 | 83.662 | 91.201 | 1.00 | 58.97 | B | C |
| ATOM | 9537 | OE1 | GLU | B | 688 | 6.875 | 84.815 | 91.472 | 1.00 | 58.33 | B | O |
| ATOM | 9538 | OE2 | GLU | B | 688 | 5.618 | 83.060 | 91.892 | 1.00 | 58.35 | B | O |
| ATOM | 9539 | C | GLU | B | 688 | 6.251 | 85.844 | 87.451 | 1.00 | 65.83 | B | C |
| ATOM | 9540 | O | GLU | B | 688 | 6.687 | 86.985 | 87.577 | 1.00 | 66.10 | B | O |
| ATOM | 9762 | N | THR | B | 716 | 0.895 | 77.642 | 83.597 | 1.00 | 58.37 | B | N |
| ATOM | 9763 | CA | THR | B | 716 | 1.199 | 77.017 | 84.881 | 1.00 | 56.38 | B | C |
| ATOM | 9764 | CB | THR | B | 716 | 1.240 | 78.061 | 86.012 | 1.00 | 61.17 | B | C |
| ATOM | 9765 | OG1 | THR | B | 716 | 0.883 | 77.443 | 87.250 | 1.00 | 61.30 | B | O |
| ATOM | 9766 | CG2 | THR | B | 716 | 0.252 | 79.171 | 85.749 | 1.00 | 62.23 | B | C |
| ATOM | 9767 | C | THR | B | 716 | 0.063 | 76.037 | 85.150 | 1.00 | 55.58 | B | C |
| ATOM | 9768 | O | THR | B | 716 | −1.091 | 76.333 | 84.846 | 1.00 | 55.90 | B | O |
| ATOM | 9769 | N | LEU | B | 717 | 0.377 | 74.873 | 85.707 | 1.00 | 58.49 | B | N |
| ATOM | 9770 | CA | LEU | B | 717 | −0.650 | 73.871 | 85.990 | 1.00 | 56.82 | B | C |
| ATOM | 9771 | CB | LEU | B | 717 | 0.030 | 72.565 | 86.429 | 1.00 | 46.67 | B | C |
| ATOM | 9772 | CG | LEU | B | 717 | 1.080 | 72.637 | 87.546 | 1.00 | 47.47 | B | C |
| ATOM | 9773 | CD1 | LEU | B | 717 | 0.367 | 72.956 | 88.843 | 1.00 | 47.98 | B | C |
| ATOM | 9774 | CD2 | LEU | B | 717 | 1.841 | 71.306 | 87.687 | 1.00 | 47.27 | B | C |
| ATOM | 9775 | C | LEU | B | 717 | −1.704 | 74.341 | 87.026 | 1.00 | 55.29 | B | C |
| ATOM | 9776 | O | LEU | B | 717 | −2.861 | 73.912 | 87.000 | 1.00 | 54.28 | B | O |
| ATOM | 9777 | N | SER | B | 718 | −1.296 | 75.244 | 87.911 | 1.00 | 41.68 | B | N |
| ATOM | 9778 | CA | SER | B | 718 | −2.168 | 75.781 | 88.945 | 1.00 | 42.21 | B | C |
| ATOM | 9779 | CB | SER | B | 718 | −1.366 | 76.674 | 89.892 | 1.00 | 57.27 | B | C |
| ATOM | 9780 | OG | SER | B | 718 | −0.140 | 76.082 | 90.265 | 1.00 | 57.44 | B | O |
| ATOM | 9781 | C | SER | B | 718 | −3.333 | 76.605 | 88.391 | 1.00 | 43.08 | B | C |
| ATOM | 9782 | O | SER | B | 718 | −4.441 | 76.544 | 88.922 | 1.00 | 43.24 | B | O |
| ATOM | 9791 | N | ASN | B | 720 | −3.278 | 79.928 | 88.251 | 1.00 | 63.03 | B | N |
| ATOM | 9792 | CA | ASN | B | 720 | −3.378 | 81.000 | 89.231 | 1.00 | 64.27 | B | C |
| ATOM | 9793 | CB | ASN | B | 720 | −2.435 | 80.722 | 90.424 | 1.00 | 56.96 | B | C |
| ATOM | 9794 | CG | ASN | B | 720 | −0.949 | 80.713 | 90.042 | 1.00 | 56.53 | B | C |
| ATOM | 9795 | OD1 | ASN | B | 720 | −0.527 | 80.050 | 89.087 | 1.00 | 56.28 | B | O |
| ATOM | 9796 | ND2 | ASN | B | 720 | −0.149 | 81.434 | 90.813 | 1.00 | 56.39 | B | N |
| ATOM | 9797 | C | ASN | B | 720 | −3.117 | 82.394 | 88.678 | 1.00 | 65.24 | B | C |
| ATOM | 9798 | O | ASN | B | 720 | −3.250 | 83.382 | 89.401 | 1.00 | 65.17 | B | O |
| ATOM | 10093 | N | GLN | B | 761 | −1.224 | 69.548 | 93.756 | 1.00 | 49.38 | B | N |
| ATOM | 10094 | CA | GLN | B | 761 | −0.541 | 70.829 | 93.565 | 1.00 | 49.08 | B | C |
| ATOM | 10095 | CB | GLN | B | 761 | 0.507 | 70.726 | 92.458 | 1.00 | 48.74 | B | C |
| ATOM | 10096 | CG | GLN | B | 761 | 1.857 | 70.217 | 92.924 | 1.00 | 50.25 | B | C |
| ATOM | 10097 | CD | GLN | B | 761 | 2.861 | 70.060 | 91.789 | 1.00 | 51.04 | B | C |
| ATOM | 10098 | OE1 | GLN | B | 761 | 3.986 | 69.612 | 92.003 | 1.00 | 51.31 | B | O |
| ATOM | 10099 | NE2 | GLN | B | 761 | 2.455 | 70.422 | 90.577 | 1.00 | 52.66 | B | N |
| ATOM | 10100 | C | GLN | B | 761 | −1.504 | 71.950 | 93.218 | 1.00 | 48.43 | B | C |
| ATOM | 10101 | O | GLN | B | 761 | −2.705 | 71.721 | 93.060 | 1.00 | 49.19 | B | O |
| ATOM | 10102 | N | GLY | B | 762 | −0.973 | 73.162 | 93.101 | 1.00 | 38.22 | B | N |
| ATOM | 10103 | CA | GLY | B | 762 | −1.806 | 74.292 | 92.764 | 1.00 | 37.62 | B | C |
| ATOM | 10104 | C | GLY | B | 762 | −1.600 | 75.500 | 93.655 | 1.00 | 38.70 | B | C |
| ATOM | 10105 | O | GLY | B | 762 | −2.200 | 76.553 | 93.445 | 1.00 | 40.36 | B | O |
| ATOM | 10106 | N | GLY | B | 763 | −0.745 | 75.383 | 94.653 | 1.00 | 39.55 | B | N |
| ATOM | 10107 | CA | GLY | B | 763 | −0.547 | 76.526 | 95.516 | 1.00 | 40.11 | B | C |
| ATOM | 10108 | C | GLY | B | 763 | −1.871 | 76.897 | 96.154 | 1.00 | 42.01 | B | C |
| ATOM | 10109 | O | GLY | B | 763 | −2.561 | 76.034 | 96.707 | 1.00 | 43.43 | B | O |
| ATOM | 10546 | N | THR | B | 821 | −2.601 | 70.694 | 98.759 | 1.00 | 42.22 | B | N |
| ATOM | 10547 | CA | THR | B | 821 | −1.712 | 70.944 | 99.891 | 1.00 | 39.50 | B | C |
| ATOM | 10548 | CB | THR | B | 821 | −0.258 | 71.108 | 99.425 | 1.00 | 20.00 | B | C |
| ATOM | 10549 | OG1 | THR | B | 821 | 0.101 | 69.985 | 98.616 | 1.00 | 20.98 | B | O |
| ATOM | 10550 | CG2 | THR | B | 821 | 0.690 | 71.209 | 100.612 | 1.00 | 15.44 | B | C |
| ATOM | 10551 | C | THR | B | 821 | −2.056 | 72.175 | 100.719 | 1.00 | 40.64 | B | C |
| ATOM | 10552 | O | THR | B | 821 | −2.080 | 72.108 | 101.944 | 1.00 | 41.93 | B | O |
| ATOM | 10775 | N | HIS | B | 853 | 5.907 | 66.188 | 91.557 | 1.00 | 38.36 | B | N |
| ATOM | 10776 | CA | HIS | B | 853 | 6.163 | 66.916 | 90.324 | 1.00 | 37.94 | B | C |
| ATOM | 10777 | CB | HIS | B | 853 | 7.647 | 67.308 | 90.224 | 1.00 | 43.77 | B | C |
| ATOM | 10778 | CG | HIS | B | 853 | 8.040 | 68.441 | 91.124 | 1.00 | 44.94 | B | C |
| ATOM | 10779 | CD2 | HIS | B | 853 | 8.405 | 69.715 | 90.845 | 1.00 | 45.52 | B | C |
| ATOM | 10780 | ND1 | HIS | B | 853 | 8.052 | 68.336 | 92.499 | 1.00 | 45.20 | B | N |
| ATOM | 10781 | CE1 | HIS | B | 853 | 8.405 | 69.495 | 93.026 | 1.00 | 45.33 | B | C |
| ATOM | 10782 | NE2 | HIS | B | 853 | 8.625 | 70.349 | 92.045 | 1.00 | 45.66 | B | N |
| ATOM | 10783 | C | HIS | B | 853 | 5.734 | 66.206 | 89.051 | 1.00 | 38.02 | B | C |
| ATOM | 10784 | O | HIS | B | 853 | 5.764 | 66.807 | 87.978 | 1.00 | 36.51 | B | O |
| ATOM | 10801 | N | GLN | B | 856 | 3.392 | 67.839 | 86.576 | 1.00 | 45.51 | B | N |
| ATOM | 10802 | CA | GLN | B | 856 | 3.628 | 68.789 | 85.476 | 1.00 | 46.12 | B | C |
| ATOM | 10803 | CB | GLN | B | 856 | 4.991 | 69.458 | 85.617 | 1.00 | 36.58 | B | C |
| ATOM | 10804 | CG | GLN | B | 856 | 5.161 | 70.155 | 86.948 | 1.00 | 36.05 | B | C |
| ATOM | 10805 | CD | GLN | B | 856 | 6.503 | 70.845 | 87.096 | 1.00 | 35.54 | B | C |
| ATOM | 10806 | OE1 | GLN | B | 856 | 7.513 | 70.400 | 86.544 | 1.00 | 35.35 | B | O |
| ATOM | 10807 | NE2 | GLN | B | 856 | 6.525 | 71.930 | 87.862 | 1.00 | 34.45 | B | N |
| ATOM | 10808 | C | GLN | B | 856 | 3.537 | 68.014 | 84.149 | 1.00 | 47.16 | B | C |
| ATOM | 10809 | O | GLN | B | 856 | 3.406 | 68.594 | 83.065 | 1.00 | 47.21 | B | O |
| ATOM | 11401 | N | ARG | B | 935 | −0.953 | 84.973 | 95.475 | 1.00 | 54.95 | B | N |
| ATOM | 11402 | CA | ARG | B | 935 | −0.476 | 84.735 | 94.118 | 1.00 | 52.80 | B | C |
| ATOM | 11403 | CB | ARG | B | 935 | 0.702 | 83.765 | 94.080 | 1.00 | 51.40 | B | C |
| ATOM | 11404 | CG | ARG | B | 935 | 2.072 | 84.404 | 94.255 | 1.00 | 50.21 | B | C |
| ATOM | 11405 | CD | ARG | B | 935 | 3.100 | 83.562 | 93.519 | 1.00 | 49.92 | B | C |
| ATOM | 11406 | NE | ARG | B | 935 | 2.793 | 82.156 | 93.732 | 1.00 | 51.19 | B | N |
| ATOM | 11407 | CZ | ARG | B | 935 | 3.207 | 81.155 | 92.965 | 1.00 | 51.30 | B | C |
| ATOM | 11408 | NH1 | ARG | B | 935 | 2.854 | 79.907 | 93.262 | 1.00 | 50.45 | B | N |
| ATOM | 11409 | NH2 | ARG | B | 935 | 3.968 | 81.396 | 91.912 | 1.00 | 51.06 | B | N |
| ATOM | 11410 | C | ARG | B | 935 | −1.590 | 84.190 | 93.249 | 1.00 | 52.62 | B | C |
| ATOM | 11411 | O | ARG | B | 935 | −1.413 | 83.188 | 92.553 | 1.00 | 52.78 | B | O |
| ATOM | 46466 | O2P | FDP | P | 2 | 2.564 | 77.669 | 89.518 | 1.00 | 64.79 | P | O |
| ATOM | 46467 | P1 | FDP | P | 2 | 2.932 | 77.562 | 91.081 | 1.00 | 65.07 | P | P |
| ATOM | 46468 | O3P | FDP | P | 2 | 1.908 | 78.563 | 91.816 | 1.00 | 64.74 | P | O |
| ATOM | 46469 | O1P | FDP | P | 2 | 4.347 | 77.907 | 91.349 | 1.00 | 64.33 | P | O |
| ATOM | 46470 | O2 | FDP | P | 2 | 2.505 | 76.087 | 91.572 | 1.00 | 64.09 | P | O |
| ATOM | 46471 | C2 | FDP | P | 2 | 3.298 | 74.903 | 91.416 | 1.00 | 61.84 | P | C |
| ATOM | 46472 | C1 | FDP | P | 2 | 2.644 | 73.782 | 92.229 | 1.00 | 62.62 | P | C |
| ATOM | 46473 | O1 | FDP | P | 2 | 2.081 | 74.192 | 93.454 | 1.00 | 63.77 | P | O |
| ATOM | 46474 | O5 | FDP | P | 2 | 4.658 | 75.066 | 91.827 | 1.00 | 59.94 | P | O |
| ATOM | 46475 | C3 | FDP | P | 2 | 3.448 | 74.488 | 89.952 | 1.00 | 61.69 | P | C |
| ATOM | 46476 | O3 | FDP | P | 2 | 3.791 | 75.620 | 89.151 | 1.00 | 61.88 | P | O |
| ATOM | 46477 | C4 | FDP | P | 2 | 4.651 | 73.547 | 90.034 | 1.00 | 60.93 | P | C |
| ATOM | 46478 | O4 | FDP | P | 2 | 4.218 | 72.190 | 89.924 | 1.00 | 62.00 | P | O |
| ATOM | 46479 | C5 | FDP | P | 2 | 5.236 | 73.816 | 91.421 | 1.00 | 59.69 | P | C |
| ATOM | 46480 | C6 | FDP | P | 2 | 6.762 | 73.833 | 91.360 | 1.00 | 61.28 | P | C |
| ATOM | 46481 | O6 | FDP | P | 2 | 7.338 | 74.231 | 92.605 | 1.00 | 62.38 | P | O |
| ATOM | 46482 | P2 | FDP | P | 2 | 8.939 | 74.344 | 92.725 | 1.00 | 62.47 | P | P |
| ATOM | 46483 | O5P | FDP | P | 2 | 9.300 | 73.929 | 94.237 | 1.00 | 62.98 | P | O |
| ATOM | 46484 | O6P | FDP | P | 2 | 9.527 | 73.192 | 91.766 | 1.00 | 62.87 | P | O |
| ATOM | 46485 | O4P | FDP | P | 2 | 9.438 | 75.687 | 92.356 | 1.00 | 62.71 | P | O |
| END | | | | | | | | | | | | |

1-3. (canceled)

4. A modulator stimulating the catalytic activity of eukaryotic phosphofructokinase (PFK) characterised in that it is established in relation to the binding site, which is a part of the PFK, in complex with the allosteric activator D-fructose-2,6-bisphosphate (Fru-2,6-P₂), wherein the experimentally established atomic coordinates x, y, z of the portion of PFK which define two homologous binding sites of the activator (effector) including the bound Fru-2,6-P₂ molecules are presented in Tables 1a and 1b, or a derivative set of transformed coordinates expressed in any reference system, where the amino acid residues from Tables 1a or 1b have been substituted with the amino acid residues present in the homologous sequence of another eukaryotic PFK and the three-dimensional structure described with the atomic coordinates x, y, z, after being superimposed by means of the least squares minimization method, has the root mean square deviation equal or less than 0.1 nm, in relation to the atomic coordinates x, y, z presented in Tables 1a or 1b and wherein the said modulator is a compound presented on FIG. 1 and where A and C are selected from among the groups: —PO₄, —SO₄ or —C—SO₂O; B is one of the bridges: —O— or —S—; D is selected from among the groups —PO₄, —SO₄, —OH or —C—SO₂O, E is —H, # is an atom C with hybridization sp³; R1 and R2 are either —CXH—OH or —CX═O or —H, where X is a hydrogen atom or a bond with other R groups or a bond with other R groups through the —CH₂—, group; and the —CH₂—groups are between D and # and between C and #.

5-6. (canceled)

7. A method of designing or selecting a PFK modulator, characterised in that it includes:
a) exploring the PFK atomic coordinates which constitute the binding site of the PKF effector presented in Tables 1a and 1b to obtain information about the three-dimensional structure of the protein surface;
b) designing or selecting a PFK modulator using the effector binding site information given in Tables 1a or 1b.

8. A method according to claim 7, of designing or selecting the PFK modulator, characterised in that the modulator is a compound of the formula presented in FIG. 1, and where A and C are selected from among the groups: —PO₄, —SO₄ or —C—SO₂O; B is one of the bridges: —O— or —S—; D is selected from among the groups —PO₄, —SO₄, —OH or —C—SO₂O; E is —H, # is an atom C with hybridization sp³, R1 and R2 are either —CXH—OH or —CX═O or —H, where X is a hydrogen atom or a bond with other R groups or a bond with other R groups through the —CH₂—, group; and the —CH₂— groups are between D and # and between C and #.

9. (canceled)

10. A method of producing the PFK modulator according to any of claim 4, 7, or 8 characterised in that it comprises the identification of a compound or designing a compound that fits into the effector site binding pocket of PFK in its uninhibited conformation, wherein the said conformation of the effector site binding pocket of PFK is defined by the x, y, z-coordinates of atoms in the set of amino acid residues given in Tables 1a or 1b.

11. A computer-based method for the analysis of the interaction of a molecular structure with PFK according to the claim 4, characterised in that it comprises:
a) providing a structure comprising a three-dimensional representation of PFK effector binding site, whose representation comprises all or a portion of the coordinates given in Tables 1a or 1b, or coordinates whose differences from those are within a root-mean-square deviation (r.m.s.d.) equal or less than 0.1 nm,
b) providing a molecular structure to be fitted to the said PFK effector binding site; and
c) fitting the molecular structure to the PFK structure of a).

12. A computer-based method for the analysis of molecular structures to be fitted to selected coordinates of at least two atoms of PFK according to the claim 4, characterised in that it comprises:
a) providing the coordinates of at least two atoms of a PFK structure as defined in Tables 1a or 1b, wherein the root mean square for the atoms is equal or less than 0.1 nm (“selected coordinates”);
b) providing the structure of a molecular structure to be fitted to the selected coordinates.

13. A method of assessing the ability of a candidate modulator to interact in the binding site on the PFK surface according to the claim 4, characterised in that it comprises the steps of:
a) obtaining or synthesising the said candidate modulator;
b) forming a crystallized complex of a PFK protein whose atomic coordinates x, y, z include the coordinates presented in Tables 1a or 1b, or the set of coordinates of a homologous part of protein or candidate modulator expressed in any reference system which, after being superimposed with the least squares minimization method, has the root mean square deviation equal or less than 0.1 nm, in relation to the atomic coordinates x, y, z presented in Tables 1a and 1b;
c) analysing the said complex by X-ray crystallography or NMR spectroscopy to determine the ability of the said candidate modulator to interact with the binding site on the PFK surface.

14. A method of providing data for generating structures and/or designing the drugs which bind the PFK, PFK homologues or analogues, complexes of PFK, or complexes of the PFK homologues or analogues with potential modulators according to the claim 4, characterised in that the communication is established with a remote device which contains the computer-readable data comprising at least one of:
a) atomic coordinate data presented in Tables 1a or 1b, or a set of coordinates expressed in any reference system which, after being superimposed with the least squares minimization method, has the root mean square deviation equal or less than 0.1 nm, when such data defines the three-dimensional structure of the effector-binding site on the PFK surface;
b) atomic coordinate data of a target effector binding site on the PFK homologue or analogue surface, generated by homology modelling of the target based on the data from Tables 1a or 1b, with the root mean square deviation from atoms equal or less than 0.1 nm;
c) receiving the said computer-readable data from a remote device.

15. A computer system comprising at least the atomic coordinate data of an effector binding site on the PFK surface, according to the claim 4 characterized in that it contains at least one of:
a) atomic coordinate data presented in Tables 1a or 1b, or such data which, after being superimposed with the least squares minimization method, has the root mean square deviation from the atoms in Tables 1a or 1b equal or less than 0.1 nm, when such data defines the three-dimensional structure of the effector-binding site on the PFK surface or at least its selected coordinates;
b) atomic coordinate data of an effector binding site on the surface of target PFK protein, generated by homology modelling of the target based on the data from Tables 1a or 1b, when the root mean square deviation from atoms from Tables 1a or 1b, after being superimposed with the least squares minimization method, is equal or less than 0.1 nm;
c) atomic coordinate data of an effector binding site on the surface of target PFK protein, generated by the interpretation of data obtained from the analysis of the X-ray crystallography or NMR, based on the data from Tables 1a or 1b, when the root mean square deviation from atoms from Tables 1a or 1b, after being superimposed with the least squares minimization method, is equal or less than 0.1 nm, and/or
d) crystallographic structure factors, obtained from the atomic coordinates (c) or (d).
